(19) United States
(12) Patent Application Publication
(10) Pub. No.: US 2026/0202709 A1
(43) Pub. Date: Jul. 16, 2026

(54) DISPLAY DEVICE

(71) Applicant: TPK Advanced Solutions Inc., Xiamen (CN)

(72) Inventors: Sheng-Fa Liu, Taoyuan City (TW); Shun-Long Lin, Xiamen City (CN); Yi-Duan Zhou, Xiamen City (CN); Chin-Hui Lee, Taipei City (TW)

(21) Appl. No.: 19/442,549

(22) Filed: Jan. 7, 2026

(30) Foreign Application Priority Data
Jan. 14, 2025 (CN) 202510054829.8
Jan. 16, 2025 (TW) 114101928

(51) Int. Cl. G02F 1/1677; G02F 1/1333; G02F 1/167; G02F 1/16757

(52) U.S. Cl. CPC G02F 1/1677; G02F 1/13338; G02F 1/167; G02F 1/16757

(57) ABSTRACT

A display device includes a cover plate, an optical module, and a color electrophoretic display module. The optical module is located under the cover plate and includes a light guide plate, a first optical layer, a second optical layer, and a light source. A first main surface of the light guide plate faces the cover plate and is provided with a plurality of concave microstructures having non-gradient shapes. The first optical layer is located on the first main surface. The second optical layer is located on a second main surface of the light guide plate. The light source is disposed on a lateral side of the light guide plate. The color electrophoretic display module is located under the optical module. A refractive index of the second optical layer is smaller than a refractive index of the light guide plate and larger than a refractive index of the first optical layer.

### CROSS-REFERENCE TO RELATED APPLICATION

This application claims priority to China Patent Application No. 202510054829.8, filed on Jan. 14, 2025, and Taiwan Patent Application No. 114101928, filed Jan. 16, 2025. China Patent Application No. 202510054829.8 and Taiwan Patent Application No. 114101928 are incorporated herein by reference.

### FIELD OF DISCLOSURE

The present disclosure relates to a display device, and more particularly relates to a display device having a front light module.

### DESCRIPTION OF RELATED ART

E-readers employ a bistable display technology that consume power only during image transitions. Compared with conventional self-emissive displays, such bistable operation can reduce power consumption by more than 90%, thereby yielding environmental benefits. In addition, replacing paper books with e-readers may reduce the loss of carbon absorption associated with deforestation, thereby supporting sustainable value through green technology.

Currently, to enable users to clearly view the content displayed by an e-reader in dark or high-light environments, e-readers commonly adopt front-light displays. A front-light display includes a front-light module and a display panel. The front-light module includes a light guide plate and a lighting unit disposed adjacent to the light guide plate. The light guide plate has a light-emitting surface. Light emitted from the lighting unit enters one end of the light guide plate and propagates toward the display panel by refraction within the light guide plate. The display panel then reflects the light back through the light guide plate toward eyes of the user. Because the front-light display forms images by reflected light, it is not as susceptible to interference from strong ambient light as self-emissive displays.

In conventional techniques, low-refractive-index materials are typically coated on both the upper and the lower surfaces of the light guide plate so that light can maintain total internal reflection within the light guide plate. This allows light to propagate from the light-source end to the opposite end of the light guide plate, similar to optical-fiber transmission with minimal energy loss. Although a large refractive-index contrast between the light guide plate and the upper and the lower surfaces of the light guide plate can better ensure the occurrence of total internal reflection, such a design may also makes it difficult for the light propagating within the light guide plate to exit toward the light guide plate, resulting in insufficient image light incident on the display panel. Furthermore, because the refractive index of the light guide plate is much higher than that of the low-refractive-index material at its lower interface, the light exiting the light guide plate toward the display panel deviates substantially from the normal of the interface between the light guide plate and the lower-refractive-index material, making it difficult to enter the display panel. Such light, which is not modulated by the display panel, constitutes noise light that causes a washed-out image. As used herein, “image light” refers to light that is modulated by the display panel to form an image, and “noise light” refers to unmodulated light that can adversely affect image quality, for example by contributing to washout, luminance non-uniformity, bright spots, or other visual artifacts.

Accordingly, there is a need in the art for a display device that can address the foregoing issues.

### SUMMARY

In view of the foregoing, one objective of the present disclosure is to provide a display device that can solve the aforementioned problems.

To achieve the aforementioned objective, according to one embodiment of the present disclosure, a display device is provided, comprising a cover plate, an optical module, and a color electrophoretic display module. The optical module is located under the cover plate and comprises a light guide plate, a first optical layer, a second optical layer, and a light source. The light guide plate has a first main surface and a second main surface opposite to each other. The first main surface faces the cover plate and is provided with a plurality of concave microstructures having non-gradient shapes. The first optical layer is located on the first main surface. A first ideal interfacial reflectance R₀₋₁ is defined between the first optical layer and the first main surface. The second optical layer is located on the second main surface. A second ideal interfacial reflectance R₀₋₂ is defined between the second optical layer and the second main surface. The light source is disposed on a lateral side of the light guide plate. The color electrophoretic display module is located under the optical module. The light guide plate has a refractive index n_{LG} ranging from about 1.55 to about 1.65. The first optical layer has a refractive index n₁ ranging from about 1.38 to about 1.41. The second optical layer has a refractive index n₂ ranging from about 1.48 to about 1.52. A ratio between the first ideal interfacial reflectance R₀₋₁ and the second ideal interfacial reflectance R₀₋₂ is from about 3 to about 13. The first ideal interfacial reflectance R₀₋₁ and the second ideal interfacial reflectance R₀₋₂ are calculated according to the following equations:

$${R}_{0 - 1} = {\vert \frac{{n}_{LG} - {n}_{1}}{{n}_{LG} + {n}_{1}} \vert}^{2} , {R}_{0 - 2} = {\vert \frac{{n}_{2} - {n}_{LG}}{{n}_{2} + {n}_{LG}} \vert}^{2} ∘$$

In one or more embodiments of the present disclosure, each of the plurality of concave microstructures comprises two inclined surfaces that are connected to each other. The two inclined surfaces are recessed from the first main surface.

In one or more embodiments of the present disclosure, the color electrophoretic display module comprises a microcapsule-based electrophoretic display and a color pixel array. The microcapsule-based electrophoretic display is located under the optical module. The color pixel array can be printed on a substrate to form a color filter, which is disposed between the optical module and the microcapsule-based electrophoretic display. Alternatively, instead of using a separate color filter disposed on the microcapsule-based electrophoretic display, the color filter functionality can be achieved by directly printing color filter patterns directly onto the front plane laminate (FPL) of the e-paper film.

In one or more embodiments of the present disclosure, the color electrophoretic display module is a color microcup electrophoretic display.

In one or more embodiments of the present disclosure, the display device further comprises a touch sensing layer. The touch sensing layer is located between the cover plate and the optical module.

In one or more embodiments of the present disclosure, the transmittance of the touch sensing layer is 85-98%.

In one or more embodiments of the present disclosure, the first optical layer is directly connected with the touch sensing layer and the first main surface.

In one or more embodiments of the present disclosure, the first optical layer is a low-reflective-index coating formed on the first main surface.

In one or more embodiments of the present disclosure, the first optical layer fully fills in the plurality of concave microstructures and forms a substantially flat surface on a side of the first optical layer opposite to the light guide plate.

In one or more embodiments of the present disclosure, the first optical layer is directly connected with the cover plate and the first main surface.

In summary, the display device of the present disclosure, by configuring the refractive index of the first optical layer, disposed on the first main surface of the light guide plate, to be lower than that of the light guide plate with a relatively large difference, noise light emitted from the first main surface can be effectively reduced. By configuring the second optical layer, disposed on the second main surface of the light guide plate, to be lower than that of the light guide plate with a relatively small difference, and by designing unequal refractive index contrasts at the upper and lower interfaces of the light guide plate with their respective adjacent materials, the amount of image light transmitted to the color electrophoretic display module can be significantly increased. Furthermore, by providing concave microstructures having non-gradient shapes on the first main surface, incident light can be directionally modulated with precision toward the color electrophoretic display module.

The aforementioned description is provided merely to illustrate the problems intended to be addressed by the present disclosure, the technical means adopted to solve them, and the advantageous effects achieved. Specific details of the present disclosure will be described in the following embodiments and accompanying drawings.

### BRIEF DESCRIPTION OF THE DRAWINGS

To make the aforementioned and other objectives, features, advantages, and embodiments of the present disclosure more readily understood, a brief description of the accompanying diagrams is provided as follows.

FIG. 1 is a schematic diagram illustrating a display device according to one embodiment of the present disclosure.

FIG. 2 is a partial schematic diagram illustrating a light guide plate and a first optical layer according to one embodiment of the present disclosure.

FIG. 3 is a schematic diagram illustrating a display device according to another embodiment of the present disclosure.

FIG. 4 is a schematic diagram illustrating a display device according to yet another embodiment of the present disclosure.

FIG. 5 is a schematic diagram illustrating a display device according to still another embodiment of the present disclosure.

FIG. 6 is a schematic diagram illustrating a display device according to further embodiment of the present disclosure.

### DETAILED DESCRIPTION

A plurality of embodiments of the present disclosure will be disclosed below with reference to drawings. For the purpose of clear illustration, many details in practice will be provided together with the following descriptions. However, these detailed descriptions in practice are for illustration only and shall not be interpreted to limit the scope, applicability, or configuration of the present disclosure in any way. That is, in some embodiments of the present disclosure, these details in practice are not required. Furthermore, for the purpose of simplifying drawings, some structures and components of the prior art shown in the drawings will be illustrated schematically.

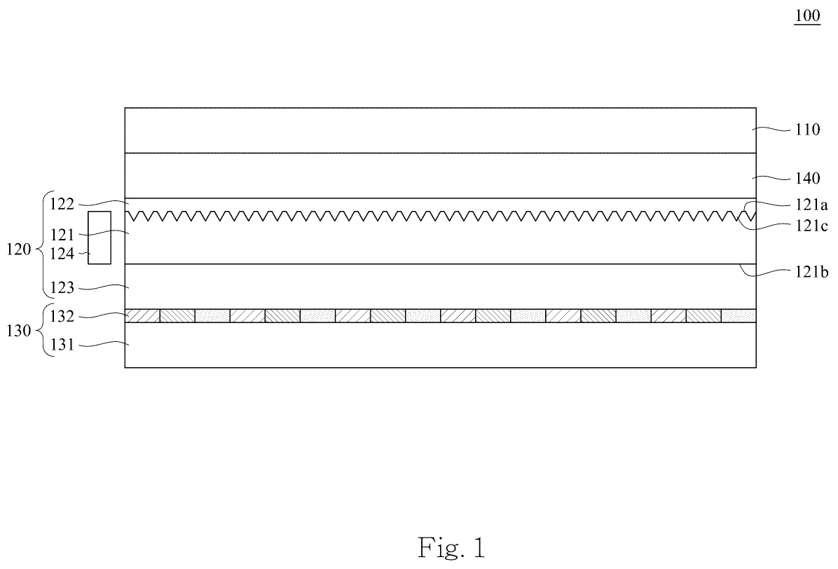

Please refer to FIG. 1, which is a schematic diagram illustrating a display device 100 according to one embodiment of the present disclosure. In the embodiment, as shown in FIG. 1, the display device 100 comprises a cover plate 110, an optical module 120, a color electrophoretic display module 130, and an optical adhesive layer 140. The optical module 120 is located under the cover plate 110 and is connected to the cover plate 110 via the optical adhesive layer 140. The color electrophoretic display module 130 is located under the optical module 120. The optical module 120 is configured to emit light toward the color electrophoretic display module 130. The color electrophoretic display module 130 is configured to modulate light emitted from the optical module 120, and reflects the modulated light sequentially through the optical module 120 and the cover plate 110 to reach eyes of a viewer. Accordingly, it can be understood that the display device 100 of the embodiment is a front-light electronic paper display (EPD).

In the embodiment, as shown in FIG. 1, the optical module 120 comprises a light guide plate 121, a first optical layer 122, a second optical layer 123, and a light source 124. The light guide plate 121 has a first main surface 121a and a second main surface 121b opposite to each other. The first main surface 121a faces the cover plate 110. The first optical layer 122 is located on the first main surface 121a. The second optical layer 123 is located on the second main surface 121b. The light source 124 is disposed on a lateral side of the light guide plate 121 and is configured to emit light into the light guide plate 121 from a side of the light guide plate 121.

In the present embodiment, the light guide plate 121 has a refractive index denoted as n_{LG}. The first optical layer 122 has a refractive index n₁, and the second optical layer 123 has a refractive index n₂. By configuring the refractive index n₁ of the first optical layer 122 to be lower than the refractive index n_{LG} of the light guide plate 121 and by ensuring that the difference between the refractive index n₁ and the refractive index n_{LG} is greater than the difference between the refractive index n₂ and the refractive index n_{LG}, most of the incident light rays at the interface between the first optical layer 122 and the light guide plate 121 exceed the critical angle according to Snell's Law and therefore undergo total internal reflection. As a result, noise light not carrying image information is effectively prevented from escaping through the first main surface 121a. In addition, by configuring the refractive index n₂ of the second optical layer 123 to be lower than the refractive index n_{LG} of the light guide plate 121 and by ensuring that the difference between the refractive index n₂ and the refractive index n_{LG} is smaller than the difference between the refractive index n₁ and the refractive index n_{LG}, fewer incident light rays at the interface between the second optical layer 123 and the light guide plate 121 exceed the critical angle and undergo total internal reflection. Consequently, light is more readily transmitted through the second main surface 121b of the light guide plate 121 into the color electrophoretic display module 130, thereby increasing the amount of image light, which carries modulated image information. In other words, since the refractive index n₂ is larger than the refractive index n₁, for the light propagating within the light guide plate 121, the proportion of rays undergoing total internal reflection at the interface between the second optical layer 123 and the second main surface 121b, is lower than that at the interface between the first optical layer 122 and the first main surface 121a. That is, light propagating within the light guide plate 121 tends to exit more readily through the second main surface 121b due to the smaller refractive index difference at that interface compared to that at the first main surface 121a. As a result, the light within the optical module 120 of the present embodiment is more likely to propagate toward the color electrophoretic display module 130, where the light is modulated into image light.

In some embodiments, the refractive index n_{LG} of the light guide plate 121 ranges from about 1.55 to about 1.65. The refractive index n₁ of the first optical layer 122 ranges about 1.38 to about 1.41. The refractive index n₂ of the second optical layer 123 ranges from about 1.48 to about 1.52. Furthermore, a first ideal interfacial reflectance R₀₋₁ is defined between the first optical layer 122 and the first main surface 121a, and a second ideal interfacial reflectance R₀₋₂ is defined between the second optical layer 123 and the second main surface 121b. The ratio between the first ideal interfacial reflectance R₀₋₁ and the second ideal interfacial reflectance R₀₋₂ is about 3 to about 13. The first ideal interfacial reflectance R₀₋₁ and the second ideal interfacial reflectance R₀₋₂ are calculated according to the following equations (1), (2).

$${R}_{0 - 1} = {\vert \frac{{n}_{LG} - {n}_{1}}{{n}_{LG} + {n}_{1}} \vert}^{2} \qquad ( 1 )$$

$${R}_{0 - 2} = {\vert \frac{{n}_{2} - {n}_{LG}}{{n}_{2} + {n}_{LG}} \vert}^{2} \qquad ( 2 )$$

Please note that when the refractive index n_{LG} of the light guide plate 121, the refractive index n₁ of the first optical layer 122, the refractive index n₂ of the second optical layer 123, the first ideal interfacial reflectance R₀₋₁ between the first optical layer 122 and the first main surface 121a, and the second ideal interfacial reflectance R₀₋₂ between the second optical layer 123 and the second main surface 121b fall within the aforementioned ranges, a significant effect can be achieved in reducing noise light emitted from the first main surface 121a and increasing the amount of image light transmitted from the second main surface 121b of the light guide plate 121 to the color electrophoretic display module 130.

A comparison table (Table 1) is provided below, showing measurement results obtained from actual experiments conducted on one embodiment of the present disclosure and two comparative examples (Comparative Example 1 and Comparative Example 2).

TABLE 1

| | | Comparative | Comparative |
|---|---|---|---|
| | Embodiment | Example 1 | Example 2 |
| Refractive Index of | 1.39 | NA | NA |
| First Optical Layer | | | |
| (n₁) | | | |
| Refractive Index of | 1.58 | 1.58 | 1.58 |
| Light Guide Plate, | | | |
| (n_{LG}) | | | |
| Refractive Index of | 1.48 | 1.405 | 1.41 |
| Second Optical | | | |
| Layer (n₂) | | | |
| Contrast Ratio | 17.3 | 16.9 | 16.2 |
| (Light Source OFF) | | | |
| Contrast Ratio | 16.8 (−2.9%) | 14.7 (−13%) | 15.3 (−5.6%) |
| (Light Source ON) | | | |
| Ratio of Ideal | 3.832 | 1 | 1 |
| Interface | | | |
| Reflectance | | | |

Referring to Table 1, in Comparative Example 1 and Comparative Example 2, both the first optical layer 122 above the light guide plate 121 and the second optical layer 123 below the light guide plate 121 adopt low-refractive-index designs. It can be observed that the resulting reductions in contrast ratio (13% and 5.65%, respectively) after the light source 124 is turned on are significantly greater than that observed in the embodiment of the present disclosure (2.9%). This indicated that the designs used in Comparative Example 1 and Comparative Example 2 are unfavorable for the effective transmission of light from the second main surface 121b of the light guide plate 121 into the color electrophoretic display module 130, and additionally increase light leakage from the first main surface 121a of the light guide plate 121.

In some embodiments of the present disclosure, the materials of the light guide plate 121 include, for example, polycarbonate (PC), polymethyl methacrylate (PMMA), or composite materials thereof, although the present disclosure is not limited thereto.

In some embodiments of the present disclosure, the first optical layer 122 is a low-reflective-index coating formed on the first main surface 121a of the light guide plate 121; however, the present disclosure is not limited thereto. In other words, the first optical layer 122 may be formed on the first main surface 121a by a coating or deposition process.

In some embodiments of the present disclosure, the materials of the first optical layer 122 include fluorine-containing resin, for example, fluorine-containing acrylic resin, although the present disclosure is not limited thereto.

In some embodiments of the present disclosure, the thickness of the optical adhesive layer 140 that connects the optical module 120 and the cover plate 110 is about 175 μm.

In some embodiments of the present disclosure, the thickness of the second optical layer 123 is about 300 μm.

In some embodiments of the present disclosure, the second optical layer 123 is an optical adhesive layer. The materials of the second optical layer 123 may include, for example, acrylic resin or silicone resin, although the present disclosure is not limited thereto.

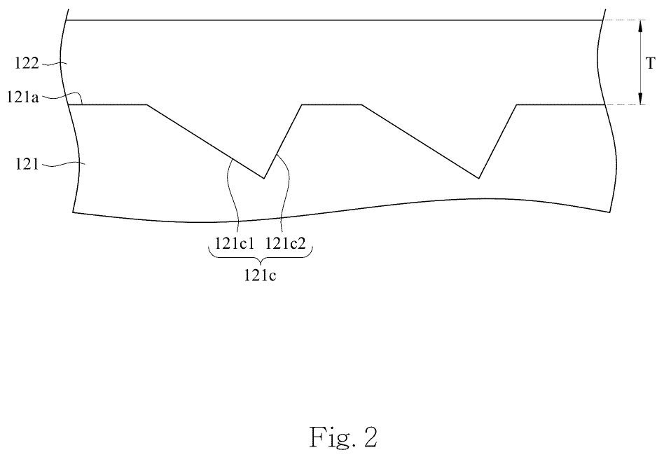

Please refer to FIG. 2, which is a partial view of a schematic diagram of the light guide plate 121 and the first optical layer 122 according to an embodiment of the present disclosure. As shown in FIG. 1 and FIG. 2, in the embodiment, a plurality of concave microstructures 121c having non-gradient shapes are provided on the first main surface 121a of the light guide plate 121. By providing the concave microstructures 121c, the direction of incident light can be modulated precisely toward the color electrophoretic display module 130. In other words, the incident light rays on the light-facing surface of the non-gradient concave microstructures 121c has a consist angle of incidence, so the light modulated by that planar incident surface is directed toward the color electrophoretic display module 130 at designed modulation angles. That is, the refracted light rays, resulting from modulation of the light emitted by the light source 124 through the non-gradient concave microstructures 121c, exhibit high directionality. If the concave microstructures 121c have gradient shapes (for example, a hemispherical shape), then the light rays emitted from the light source 124 would be incident on a curved, gradient light-receiving surface. As a result, the modulated light would be refracted in various directions depending on the angle between the light-facing surface and the incident light. While this may improve light uniformity, the light rays entering the color electrophoretic display module 130 would come from a variety of incident directions, which would ultimately reduce the contrast ratio and color saturation of the display compared to the use of non-gradient concave microstructures 121c.

As shown in FIG. 2, in the present embodiment, each concave microstructure 121c comprises two inclined surfaces 121c1, 121c2 that are connected. These two inclined surfaces 121c1 and 121c2 are recessed from the first main surface 121a. Specifically, for each concave microstructure 121c, the inclined surface 121cl is a light-facing surface positioned closer to the light source 124, while the inclined surface 121c2 is a rear-facing surface located farther from the light source 124. The surface area of the inclined surface 121c1, serving as the light-facing surface, is larger than that of the inclined surface 121c2, serving as the rear-facing surface. As such, the concave microstructures 121c on the first main surface 121a of the light guide plate 121 can effectively increase the amount of incident light that is modulated and redirected, thereby enhancing the amount of light directed from the first main surface 121a toward the color electrophoretic display module 130.

In some embodiments of the present disclosure, the angle formed between the two inclined surfaces 121c1, 121c2 of each concave microstructure 121c ranges from about 40 degrees to about 70 degrees. This effectively redirects incident light emitted from the light source 124 by the first main surface 121a so that the incident light enters the color electrophoretic display module 130 in a direction perpendicular thereto.

In some embodiments of the present disclosure, the distribution density of the concave microstructures 121c on the first main surface 121a has an exponential relationship with the distance from the light source 124. For example, the distribution density of the concave microstructures 121c is proportional to the square of the distance from the light source 124; however, the present disclosure is not limited thereto.

In some embodiments of the present disclosure, the upper surface of the first optical layer 122 that covers the concave microstructures 121c is substantially flat, so as to avoid disturbance in the propagation direction or attenuation of the energy of the light rays reflected from the color electrophoretic display module 130 when propagating through an uneven interface.

In some embodiments of the present disclosure, the refractive index of the first optical layer 122 covering the concave microstructures 121c is lower than that of the light guide plate 121, and the difference in refractive indices is relatively large. Compared with selecting an optical layer having a refractive index closer to that of the light guide plate 121, the probability of total internal reflection occurring at the interface between the optical layer and each of the two inclined surfaces 121c1, 121c2 of the concave microstructures 121c is higher. In other words, at the interfaces between the concave microstructures 121c and the optical layer, the propagation of light is mainly in designated directions that are modulated by the inclination angles of the inclined surfaces 121c1 and 121c2 as a result of total internal reflection. That is, the directionality of the modulated light is enhanced, thereby achieving the effect that as much as possible of the incident light emitted from the light source 124 can enter the color electrophoretic display module 130. In some embodiments, the first optical layer 122 completely fills the concave microstructures 121c without leaving air gaps, and the first optical layer 122 forms a substantially flat surface on a side of the first optical layer 122 opposite to the light guide plate 121. In some embodiments, after the first optical layer 122 completely fills the concave microstructures 121c, the substantially flat surface thus formed has a thickness T of about 10 μm measured from the first main surface 121a (see FIG. 2). In some embodiments, the first optical layer 122 is formed on the first main surface 121a by a coating or deposition process.

As shown in FIG. 1, in the present embodiment, the color electrophoretic display module 130 comprises a microcapsule-based electrophoretic display 131 and a color pixel array 132. The microcapsule-based electrophoretic display 131 is located under the optical module 120. The color pixel array 132 is disposed between the optical module 120 and the microcapsule-based electrophoretic display 131. The color pixel array 132 comprises a plurality of sub-pixel regions having different colors (for example, red, green, and blue). The microcapsule-based electrophoretic display 131 comprises a plurality of black-and-white electronic ink capsules. By controlling the grayscale variation of the electronic ink capsules located beneath different sub-pixel regions, the color electrophoretic display module 130 can produce a full-color image effect.

Because the subpixel regions of the color pixel array 132 display colors by absorbing certain wavelength bands of white light and transmitting the remaining wavelength bands, and because ambient light must pass through the color pixel array 132 twice (i.e., in a forward path and a return path), the color pixel array 132 significantly reduces the energy utilization efficiency. As a result, under typical ambient conditions, the color electrophoretic display module 130 appears dimmer than a black-and-white electrophoretic display module. Therefore, as compared with a black-and-white electrophoretic display module, the color electrophoretic display module 130 has a greater need for a front light module to increase image brightness. In particular, by virtue of the interfacial reflectance design of the front light module of the present disclosure, after the color electrophoretic display module 130 is illuminated by the front light module, noise light is reduced and image light is increased, and the reflective light modulated by subpixel regions of different colors does not mix with each other, thereby improving overall image display quality.

In some embodiments of the present disclosure, the microcapsule-based electrophoretic display 131 comprises a barrier layer (not shown). The refractive index of the barrier layer is about 1.6. Because the barrier layer has a refractive index close to that of the materials in contact with the barrier layer at the upper and lower interfaces, most of the light at these interfaces can pass through the boundaries between different materials and continue to propagate, rather than being reflected and attenuated due to refractive index difference. Accordingly, as much as possible of the light exiting from the second main surface 121b of the light guide plate 121 can enter the microcapsule-based electrophoretic display 131. For example, an ideal interface reflectance between the barrier layer and the second optical layer 123 is 0.15%.

In some embodiments of the present disclosure, a color filter pattern can be provided in an electronic paper front plane laminate (FPL) so as to replace a color filter that is separately provided on the microcapsule-based electrophoretic display 131.

In some embodiments of the present disclosure, light exiting the second main surface 121b of the light guide plate 121 enters the color electrophoretic display module 130 through a stack-up design intended to form an optical energy-cascade configuration. That is, the energy losses among the stacked layers between the light guide plate 121 and the reflective particles in the color electrophoretic display module 130 are made approximately similar. Additionally, the light does not undergo a substantial change in propagation direction along its optical path. For example, the layers are formed of materials with similar properties, such as materials with similar refractive indices, to constitute the layers present between the light guide plate 121 and the color electrophoretic display module 130. By way of example, the ideal interfacial reflectance between adjacent layers is less than 0.15%. For example, the ideal interfacial reflectance between the second optical layer 123 and the protective layer (not shown) of the color electrophoretic display module 130 is less than 0.15%. As another example, the ideal interfacial reflectance between the protective layer and a driving electrode backplane (not shown) within the color electrophoretic display module 130 is less than 0.15%, although the present disclosure is not limited thereto. In some embodiments, through such an energy-cascade stack-up design, about 90 to about 99% of the light exiting from the second main surface 121b of the light guide plate 121 can enter the color electrophoretic display module 130.

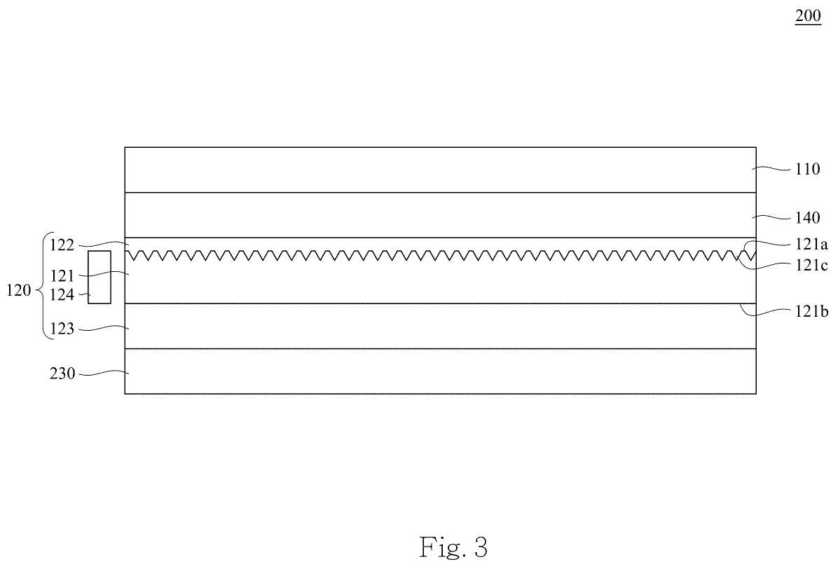

Please refer to FIG. 3, which is a schematic diagram illustrating a display device 200 according to another embodiment of the present disclosure. As shown in FIG. 3, in the present embodiment, the display device 200 comprises a cover plate 110, an optical module 120, a color electrophoretic display module 230, and an optical adhesive layer 140. The cover plate 110, the optical module 120, and the optical adhesive layer 140 are the same as those in the embodiment shown in FIG. 1, and thus the foregoing descriptions may be referred to and are not repeated herein. The difference between the present embodiment and the embodiment shown in FIG. 1 is that the color electrophoretic display module 230 of the present embodiment is a microcup color electrophoretic display. A color microcup electrophoretic display includes numerous microscopic cup-like structures, and each microcup is filled with charged particles having different colors. When the electric field is applied to the microcups, the charged particles are acted upon by an electric-field force and move upward and downward in the liquid. By controlling the electric-field force, particles of different colors can be positioned at desired locations within the microcups, thereby displaying a desired color. However, the wall of the cup-like structures in the microcup color electrophoretic display have a certain thickness. If the incident light is not perpendicular to the display surface of the cup-like structures (i.e., the surface facing the user), the incident light may be refracted by the wall material before reaching the charged particles, thereby resulting in poor display performance. Accordingly, by virtue of the interfacial reflectance design of the front light module of the present disclosure, the incident light entering the color electrophoretic display module 230 is more perpendicular to the display surface of the color electrophoretic display module 230, thereby improving overall image display quality.

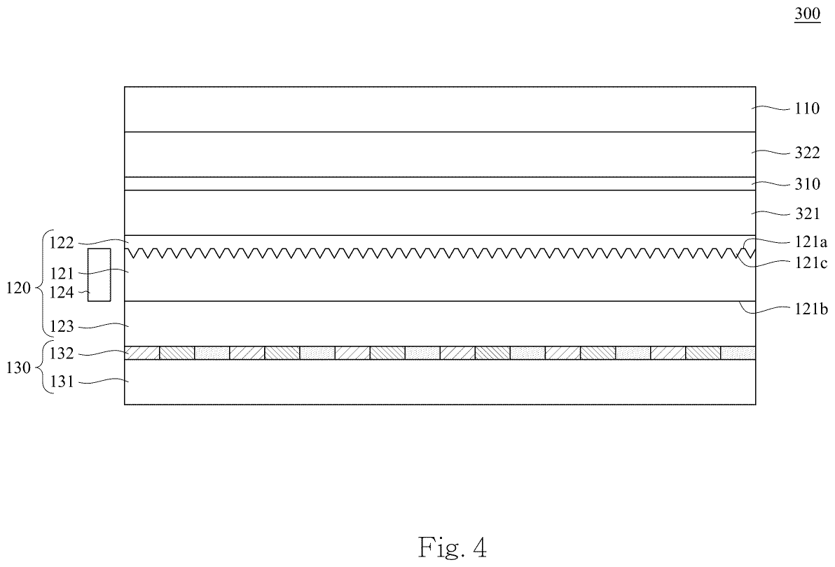

Please refer to FIG. 4, which is a schematic diagram illustrating a display device 300 according to another embodiment of the present disclosure. As shown in FIG. 4, in the present embodiment, the display device 300 comprises a cover plate 110, an optical module 120, a color electrophoretic display module 130, optical adhesive layers 321, 322, and a touch sensing layer 310. The cover plate 110, the optical module 120, and the color electrophoretic display module 130 are the same as those in the embodiment shown in FIG. 1, and thus the foregoing descriptions may be referred to and are not repeated herein. The difference between the present embodiment and the embodiment illustrated in FIG. 1 is that, in the display device 300 of the present embodiment, a touch sensing layer 310 is additionally provided between the cover plate 110 and the optical module 120. The first optical layer 122 is connected to the touch sensing layer 310 via the optical adhesive layer 321. The cover plate 110 is connected to the touch sensing layer 310 via the optical adhesive layer 322. Accordingly, the display device 30 of the present disclosure can further provide a touch function.

In some embodiments of the present disclosure, in order to reduce interfacial reflection along the optical path, the touch sensing layer 310 may employ a substrate having a refractive index close to that of the optical adhesive layers 321 and 322. For example, the optical adhesive layers 321 and 322 may have a refractive index of about 1.48, and the substrate of the touch sensing layer 310 may have a refractive index of about 1.6, although the present disclosure is not limited thereto. For example, an ideal interfacial reflectance between the optical adhesive layers 321 and 322 and the touch sensing layer 310 is 0.15%. In some embodiments, the touch sensing layer 310 may use a plastic substrate, particularly a substrate having a refractive index close to that of the optical adhesive layers 321 and 322; for example, polyethylene terephthalate (PET) may be used as the substrate of the touch sensing layer 310. In some embodiments, the touch sensing layer 310 may use a transparent metal oxide as an electrode material, particularly an electrode material having a refractive index close to that of the optical adhesive layers 321 and 322; for example, indium tin oxide (ITO) may be used as the electrode material of the touch sensing layer 310. Through selecting materials having appropriate refractive indices, the light transmittance through the touch sensing layer 310 can be 85% to 98%.

In some embodiments, the materials of at least one of the optical adhesive layers 321 or 322 may include, for example, acrylic resin, although the present disclosure is not limited thereto.

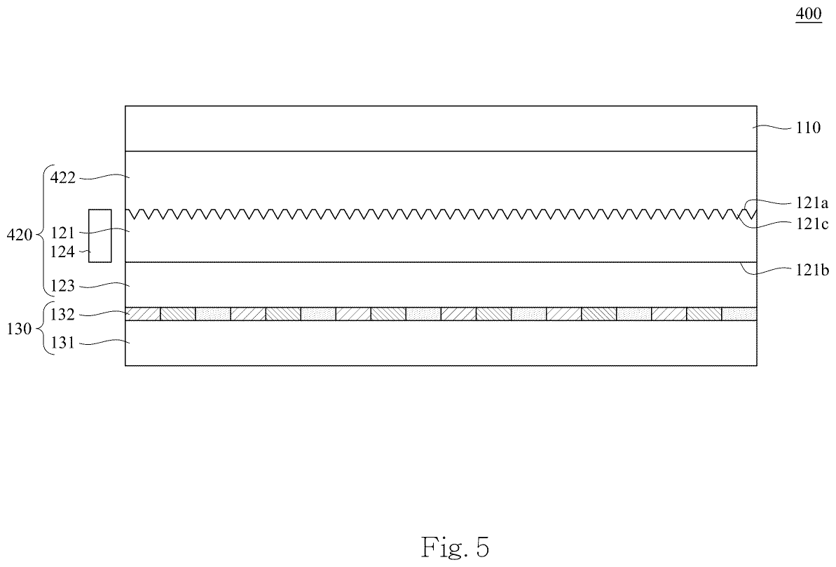

Please refer to FIG. 5, which is a schematic diagram illustrating a display device 400 according to another embodiment of the present disclosure. As shown in FIG. 5, in the present embodiment, the display device 400 comprises a cover plate 110, an optical module 420, and a color electrophoretic display module 130. The cover plate 110 and the color electrophoretic display module 130 are the same as those in the embodiment shown in FIG. 1, and thus the foregoing descriptions may be referred to and are not repeated herein. The difference between the present embodiment and the embodiment shown in FIG. 1 is that, in the display device 400 of the present embodiment, a first optical layer 422 of the optical module 420 is directly connected between the cover plate 110 and the first main surface 121a of the light guide plate 121. Particularly, the first optical layer 422 is an optical adhesive layer, which is selected to have a refractive index of about 1.38 to about 1.41. In some embodiments, the optical adhesive selected as described above has a refractive index of 1.405. This approach can achieve the technical effects described above, including increasing image light and reducing light leakage, and can further simplify the manufacturing process.

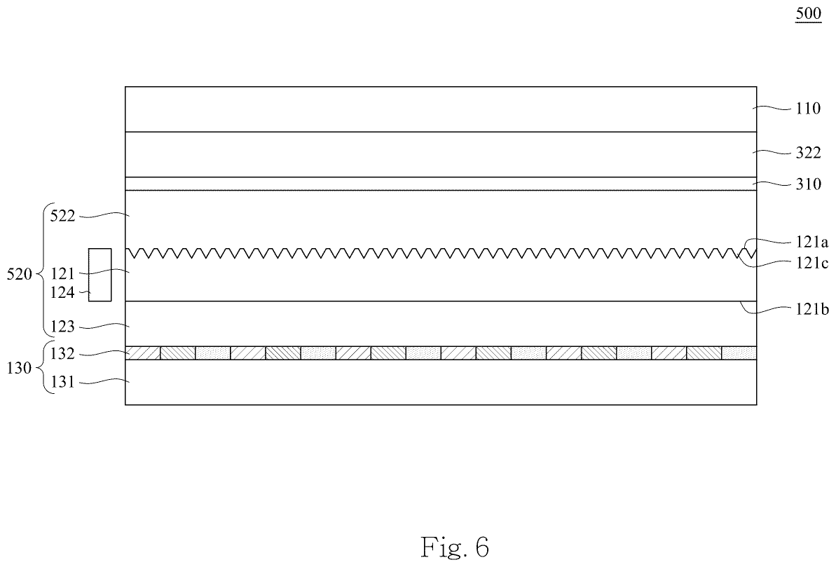

Please refer to FIG. 6, which is a schematic diagram illustrating a display device 500 according to another embodiment of the present disclosure. As shown in FIG. 6, in the present embodiment, the display device 500 comprises a cover plate 110, an optical module 520, a color electrophoretic display module 130, an optical adhesive layer 322, and a touch sensing layer 310. The cover plate 110, the color electrophoretic display module 130, the optical adhesive layer 322, and the touch sensing layer 310 are the same as those in the embodiment shown in FIG. 4 and thus the foregoing descriptions may be referred and are not repeated herein. The difference between the present embodiment and the embodiment shown in FIG. 4 is that, in the display device 500 of the present embodiment, a first optical layer 522 of the optical module 520 is directly connected between the touch sensing layer 310 and the first main surface 121a of the light guide plate 121. In particular, the first optical layer 522 is an optical adhesive layer, which is selected to have a refractive index of about 1.38 to about 1.41. In some embodiments, the optical adhesive selected as described above has a refractive index of 1.405. This approach can achieve the technical effects described above, including increasing image light and reducing light leakage, and can further simplify the manufacturing process.

From the aforementioned detail descriptions of specific embodiments of the present disclosure, it can be clearly seen that, in the display device of the present disclosure, by configuring the refractive index of the first optical layer disposed on the first main surface of the light guide plate to be lower than that of the light guide plate with a relatively small difference, noise light emitted from the first main surface can be effectively reduced. By configuring the refractive index of the second optical layer disposed on the second main surface of the light guide plate to have a refractive index lower than that of the light guide plate with a relatively small difference, and by designing the reflective index difference at the upper and lower interfaces of the light guide plate with their respective adjacent materials to be unequal, the amount of image light propagating to the color electrophoretic display module can be effectively increase. In addition, by providing concave microstructures having non-gradient shapes on the first main surface, the direction of incident light can be modulated precisely toward the color electrophoretic display module.

The above preferred embodiments are presented to disclose the present disclosure and shall not be interpreted to limit the scope, applicability, or configuration of the present disclosure in any way. Those skilled in the art may use any alternative embodiments that are modified or changed without departing from the spirit and scope of the present disclosure and shall be included in the appended claims.

### COMPONENT SYMBOL

100, 200, 300, 400, 500: Display device
110: Cover plate
120, 420, 520: Optical module
121: Light guide plate
121a: First main surface
121b: Second main surface
121c: Concave microstructure
121c1, 121c2: Inclined surface
122, 422, 522: First optical layer
123: Second optical layer
124: Light source
130, 230: Color electrophoretic display module
131: Microcapsule-based electrophoretic display
132: Color filter array (CFA)
140, 321, 322: Optical adhesive layer
310: Touch sensing layer
T: Thickness

What is claimed is:

1. A display device comprising:
a cover plate;
an optical module located under the cover plate and comprising:
a light guide plate having a first main surface and a second main surface opposite to each other, wherein the first main surface faces the cover plate and has a plurality of concave microstructures having non-gradient shapes;
a first optical layer located on the first main surface, wherein a first ideal interfacial reflectance R₀₋₁ is defined between the first optical layer and the first main surface;
a second optical layer located on the second main surface, wherein a second ideal interfacial reflectance R₀₋₂ is defined between the second optical layer and the second main surface; and
a light source disposed on a lateral side of the light guide plate; and
a color electrophoretic display module located under the optical module,
wherein the light guide plate has a refractive index n_{LG} of about 1.55 to about 1.65, the first optical layer has a refractive index n₁ of about 1.38 to about 1.41, and the second optical layer has a refractive index n₂ of about 1.48 to about 1.52,
wherein a ratio of the first ideal interfacial reflectance R₀₋₁ and the second ideal interfacial reflectance R₀₋₂ is about 3 to about 13, and
wherein the first ideal interfacial reflectance R₀₋₁ and the second ideal interfacial reflectance R₀₋₂ are calculated according to the following equations:
$${R}_{0 - 1} = {\vert \frac{{n}_{LG} - {n}_{1}}{{n}_{LG} + {n}_{1}} \vert}^{2} , {R}_{0 - 2} = {\vert \frac{{n}_{2} - {n}_{LG}}{{n}_{2} + {n}_{LG}} \vert}^{2} ∘$$

2. The display device of claim 1, wherein each of the plurality of concave microstructures comprises two inclined surfaces connected to each other, and wherein the two inclined surfaces are recessed from the first main surface.

3. The display device of claim 1, wherein the color electrophoretic display module comprises:
a microcapsule-based electrophoretic display located under the optical module; and
a color pixel array disposed between the optical module and the microcapsule-based electrophoretic display.

4. The display device of claim 1, wherein the color electrophoretic display module is a microcup color electrophoretic display.

5. The display device of claim 1, further comprising a touch sensing layer disposed between the cover plate and the optical module.

6. The display device of claim 5, wherein the touch sensing layer has a light transmittance of 85% to 98%.

7. The display device of claim 5, wherein the first optical layer is directly connected between the touch sensing layer and the first main surface.

8. The display device of claim 1, wherein the first optical layer is a low-refractive-index coating formed on the first main surface.

9. The display device of claim 1, wherein the first optical layer completely fills the plurality of concave microstructures, and the first optical layer forms a substantially flat surface on a side of the first optical layer away from the light guide plate.

10. The display device of claim 1, wherein the first optical layer is directly connected between the cover plate and the first main surface.
